(19) United States
(12) Patent Application Publication
(10) Pub. No.: US 2026/0235156 A1
(43) Pub. Date: Aug. 13, 2026

(54) Connector with a Safety Gate

(71) Applicant: KONG S.P.A., Monte Marenzo (LC) (IT)

(72) Inventors: Marco Bonaiti, Monte Marenzo (IT); Livio Corsale, Nova Milanese (IT)

(21) Appl. No.: 19/471,050

(22) PCT Filed: Jan. 17, 2024
(86) PCT No.: PCT/IB2024/050448

§ 371 Date: Sep. 30, 2025

(30) Foreign Application Priority Data
Apr. 20, 2023 (IT) 102023000007719

(51) Int. Cl. F16B 45/02

(52) U.S. Cl. CPC F16B 45/023; F16B 45/024; F16B 45/028

(57) ABSTRACT

A connector or carabiner is provided, wherein a gate coupled with an oscillating finger is adapted to ensure an improved closed condition thereof. The gate is movable along its longitudinal axis and rotatable about it for opening and closing the finger. The gate includes at least one safety notch, which engages with a septum of the nose of the carabiner when the finger makes a movement other than those of the sequence of movements required for opening it.

### BACKGROUND OF THE DISCLOSURE

### 1. The Field of the Disclosure

The present invention relates to a connector of the type intended for fastening a person engaged with ropes, cords or the like while, for example, working on building sites or performing maintenance work at an altitude, or while climbing mountains or enjoying suspended paths in adventure parks.

### 2. The Relevant Technology

Before proceeding any further, it is necessary to point out that, as will become apparent in the following description, the term “connector” refers to what is commonly called a “carabiner” or “karabiner”.

In the following, all such denominations should be understood to be synonyms having the same meaning.

As is known, a carabiner is essentially a special oblong metal ring which may have different shapes and dimensions, and which is provided with a spring-type element which ensures the correct closing of the hook, which, when closed, assumes the characteristics of a ring.

Such a connector is generally used for hanging or suspending bodies, and finds particular application in the mountaineering field, where it is absolutely necessary for making on-wall manoeuvres, but it is also widely employed for many maintenance, construction, repair, cleaning, etc. operations that have to be carried out at an altitude on buildings or on various civil and industrial structures.

Let us consider, for example, maintenance and cleaning of skyscraper facades, working on wind turbines or telecommunications antennas, mountain rescue operations, or fire brigades' activities.

Within the frame of such applications, a wide variety of carabiners are available, which differ in shape, size and materials.

Although the invention is applicable to all such variants, it has been specially developed for those carabiners equipped with a safety gate, the latter being a bushing that can be moved into an inoperative retracted position, in which it allows the carabiner to be opened by moving its elastically oscillating lever, or into an advanced position, in which it locks the lever, thereby keeping the carabiner closed.

The gate may either be threaded or feature spring-controlled snap-type elastic operation; this system is useful to prevent the carabiner's lever, when closed, from opening accidentally. This is advantageous when a person needs to secure him/herself while climbing a wall or manoeuvering in dangerous conditions.

In fact, when a carabiner is positioned with the lever-equipped arm in contact with a wall, the movement of the carabiner itself may open the lever, thus creating a dangerous situation or even causing the user to fall. A lever locked by means of a gate overcomes this problem.

Carabiners must comply with precise technical specifications as concerns their mechanical properties, such as ultimate tensile strength, fatigue strength, number of lever opening cycles.

Carabiners for climbing and mountaineering applications, just like those for work or leisure use, are considered as individual protection devices and must be certified to comply with applicable regulations; for Europe, such regulations are specified in CEN standards (EN 362 and EN 12275); carabiners for climbing and mountaineering applications may also be UIAA certified: such certification specifies, in some cases, slightly higher ultimate tensile strength values, thus requiring the manufacturers to comply with more stringent constraints.

As a safety requirement, the EN 362-EN 12275 standards also specify that at least two movements must be made in order to open the carabiner:
EN 362-4.1.3: single-lever connectors must have an automatic or manual lever locking function;
EN 362-4.1.4: connectors with a single self-locking lever must automatically lock the lever as it is closed, and must require at least two different intentional manual actions for opening it.

Whatever the applicable technical standards, the safety requirement is, for connectors or carabiners, of the utmost importance because it is from such requirement that the safety of people using such connectors for working or sporting activities depends.

Therefore, the need is constantly felt for improving the performance of such connectors under this aspect.

For example, in automatic carabiners requiring two movements to open (turning the gate about its axis+opening the lever) or in those requiring three movements (translating the gate along its axis+turning the gate about its axis+opening the lever), when the force that has caused the carabiner to open ceases, they will automatically close again, during any opening phase, and return into their initial position.

In these cases, in order to ensure intentional opening safety, two or three movements have to be made in succession to minimize the risk of accidental opening, but an unintentional force vector acting simultaneously on the ⅔ movements and oriented in the directions of such movements might nevertheless be able to open the carabiner.

Let us think, for example, of the case wherein a person secured with ropes and carabiners loses grip while working at an altitude on a building or while rock climbing: in such circumstances, the person's body may assume upside-down positions, and the tension of the ropes passing through the carabiner may act unpredictably upon the gate and the closing lever, so much so as to cause the latter to open.

### SUMMARY OF THE DISCLOSURE

The invention aims at eliminating, or at least reducing to a minimum, this risk, thus improving the degree of safety of connectors or carabiners.

In other words, the technical problem at the basis of the invention is to provide a novel connector or carabiner of the type including a safety gate for the closing function, and having such structural and functional characteristics as to ensure increased safety over prior-art carabiners.

The idea that solves this problem is to allow the mechanism to discern between intentional opening and accidental opening based on the correct sequence of the movements required for opening the carabiner.

In fact, by requiring a mandatory sequence of movements of the parts of the carabiner in order to open it, the carabiner can be prevented from opening whenever the exact sequence is not observed.

Thus, whenever a single unintentional external force triggers a movement before the previous movement has begun, that is, when the correct sequence is not observed, the safety system will enter a safety locking mode wherein the previous movement will be prevented until such force stops being applied and the system returns, in the absence of any external stimuli, into the initial condition.

The features of the invention are specifically set out in the appended claims.

### BRIEF DESCRIPTION OF THE DRAWINGS

Such features will become more apparent in light of the description that follows, with reference to the accompanying drawings, wherein:

FIG. 1 shows an exploded view of a connector or carabiner according to the invention;

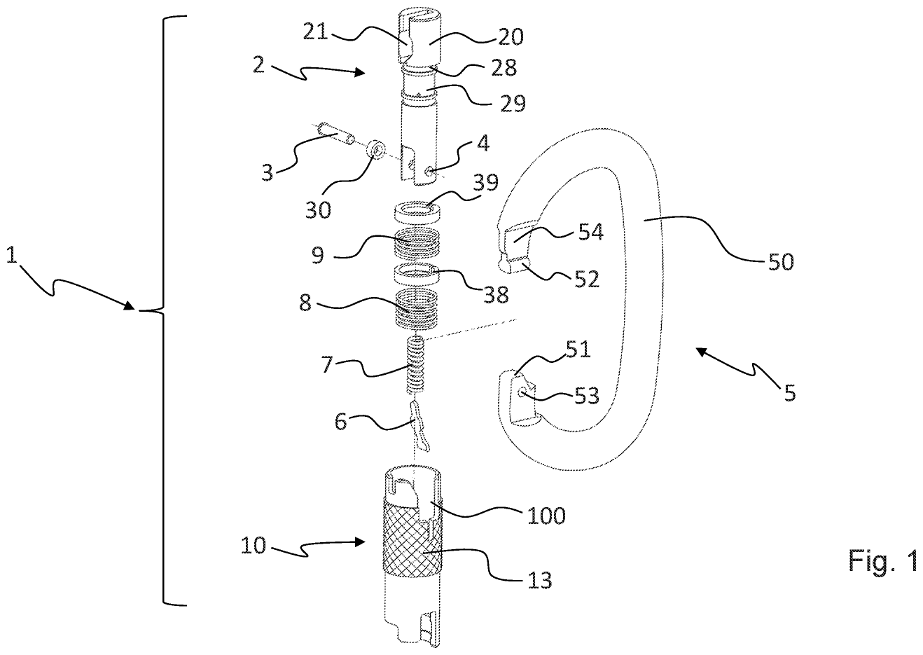

FIGS. 2 and 3 show, respectively, a side view and a top view of the connector of FIG. 1 in the assembled condition;

FIGS. 4 and 5 show axonometric views of the preceding connector in respective safe operative conditions;

FIGS. 6 and 7 show side views of the preceding connector in the respective safe operative conditions shown in FIGS. 4 and 5;

FIGS. 8 and 9 show longitudinal sectional views of the preceding connector in respective safe operative conditions;

FIGS. 10 (a), (b), (c) are views of the gate of the preceding connector from different angles;

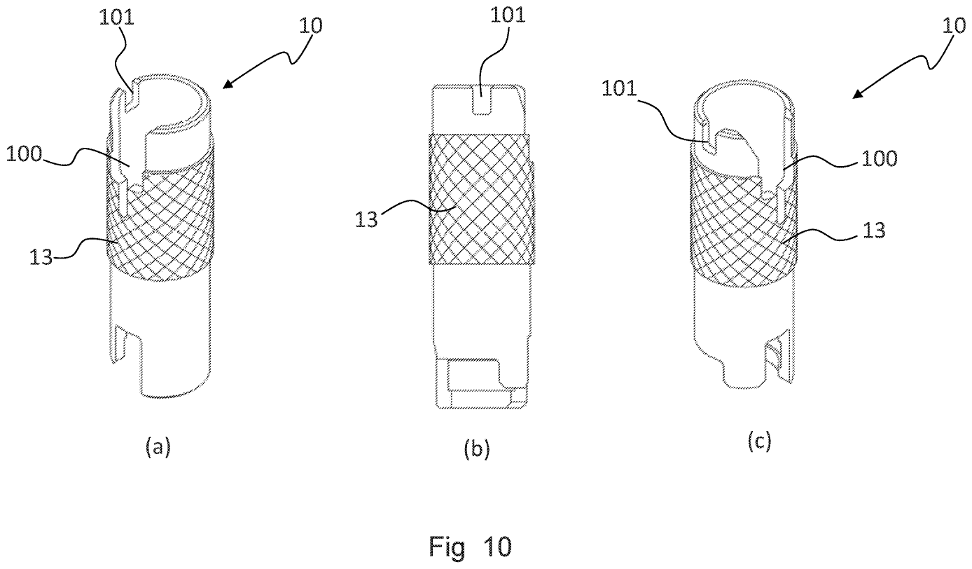

FIG. 11 shows an exploded view of a variant of the connector or carabiner according to the invention;

FIGS. 12 and 13 show axonometric views of the preceding variant of the connector in respective safe operative conditions;

FIGS. 14 and 15 show longitudinal sectional views of the preceding variant of the connector in respective safe operative conditions.

### DETAILED DESCRIPTION OF THE PREFERRED EMBODIMENTS

With reference to the above-listed drawings, the first figure shows a connector in accordance with the invention, designated as a whole by reference numeral 1.

The connector 1 has a closed oblong profile, substantially oval in shape, although it may be configured otherwise, e.g. with a circular shape, a “D” shape, an “8” shape, or any other shape known in the art.

The connector comprises a lever-type finger 2, which can oscillate about a pivot 3 located at a first end 51 of the body or hook 50 of the connector; more specifically, the pivot 3 consists of a pin passing through a hole 4 in the fork-shaped base 23 of the finger, preferably associated with a bushing 30 for friction and stress reduction. The pin 3 extends also into a hole 53 formed in the first end 51 of the body 5 of the connector 1.

The tip 20 of the oscillating finger 2 is intended to abut on the second end 52 of the body 5, which has a “C” shape; the second end 52 of the body 5 is also referred to as connector nose.

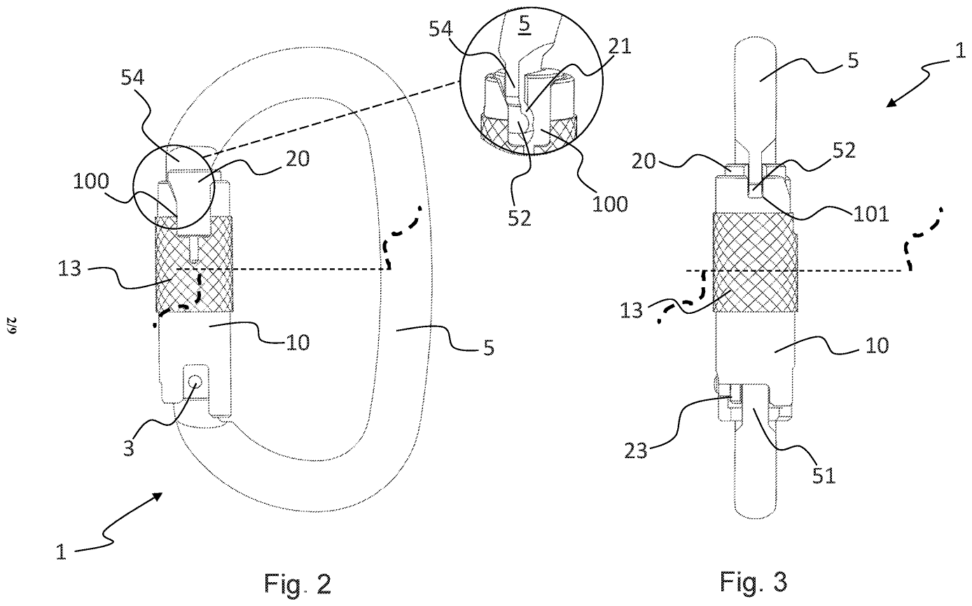

The tip 20 of the finger has an internal seat 21 having a shape complementary to that of the nose 52 of the connector 1, with which it is coupled and in abutment when the connector is in the closed condition (FIG. 2 shows a magnified detail representing the instant, during the dynamics of the automatic closing process, at which the gate 10, as it turns, hits the septum 54 of the nose 52 of the connector, where the inclined bevel helps the gate to slide into its original position).

The elastic action of a spring 7 housed within the finger 2 keeps it in abutment with the nose 52; when the connector is in the assembled condition, the spring 7 is held in position within the finger 2 by a foil 6.

In this example, the shapes of the nose 52 and of the seat 21 are of the male-female type to allow the former to fit into the latter as the finger 2 is turned outwards for closing the connector 1.

Other shapes of the seat 21 and nose 52 are nevertheless possible as well without departing from the teaching of the present invention, as will become apparent below.

A safety gate 10 is applied externally and coaxially to the finger 2 to secure the connector 1 in the closed condition, which gate is also movable between an advanced position, in which it locks the finger 2 into the closed condition, and a retracted position, in which it permits the finger 2 to oscillate in a lever-like fashion.

For this purpose, the gate 10 and the finger 2 are mutually coupled by a mechanism of joints and springs 8, 9; the gate 10 is preferably also provided with an external knurl 13, which makes it easier to grip with the phalanxes of the fingers of a user's hand.

In this example, with the connector in the assembled condition, the springs 8, 9 are held in position at corresponding grooves or cavities 28, 29 of the finger 2 by means of washers 38, 39.

In particular, the springs 8 and 9 make it possible to operate the gate 10 by carrying out a predefined sequence of movements in contrast to their elastic action, which movements include:
i) an axial translational movement upwards (with reference to the drawings);
ii) a clockwise rotational movement.

Such movements of the gate 10 bring an upper notch 100 thereof into alignment with the nose 52 of the body 5, so that the finger 2 can be turned inwards against the action of the spring 7, thereby opening the connector 1.

The inward movement of the finger 2 is, therefore, a third movement iii) of the sequence that needs to be executed to ensure the safety of the connector 1.

In other words, the sequence of movements i), ii), iii) provides the connector with a degree of intrinsic safety because it cannot be opened without executing such sequence in that exact order. In this regard, it must be pointed out that the three successive movements i)→ii)→iii) must be made intentionally by the user, since they need to overcome the elastic contrast exerted by the spring 8, 9 and 7 (in this order).

Vice versa, by executing the same sequence in the reverse order iii)→ii)→i) it is possible to safely close the connector 1 by bringing the gate 10 back into the lowered condition, turned in such a way as to bring the notch 100 out of alignment with the nose 52 of the body 5.

The reverse sequence is facilitated by the elastic return action of the springs 7, 9 and 8, which in this condition operate concordantly with the movement that the gate 10 must make.

FIGS. 2 and 3 show the connector 1 in the idle condition, i.e. in the closed condition and with no external forces being applied thereto; in this condition, the nose 52 of the body 5 is engaged in the seat 21 in the tip 20 of the finger 2.

As can be observed, in this condition the main notch 100 of the gate 10 is not aligned with the nose 52 (being turned by approx. 90°); in the position corresponding to the nose 52 there is, instead, a second notch 101 of the gate 10, smaller than the first one and substantially sized like a septum 54 associated with the nose 52 of the body 5.

The function performed by this second notch 101 is to ensure that, should an external force tend to move the lever-like finger 2 inwards starting from the idle condition of the connector (FIGS. 2 and 3), the septum 54 will project into the notch and prevent the gate from turning.

Thus, the second movement ii) of the above-mentioned sequence will not be allowed to occur.

This means that an additional phase iv) has been added to the above-described sequence in order to improve the overall safety of the connector.

In this case, in fact, even in the presence of a force tending to move the finger 2 inwards, the gate 10 will not be able to turn, and therefore the entire sequence i)→ii)→iii) will be locked.

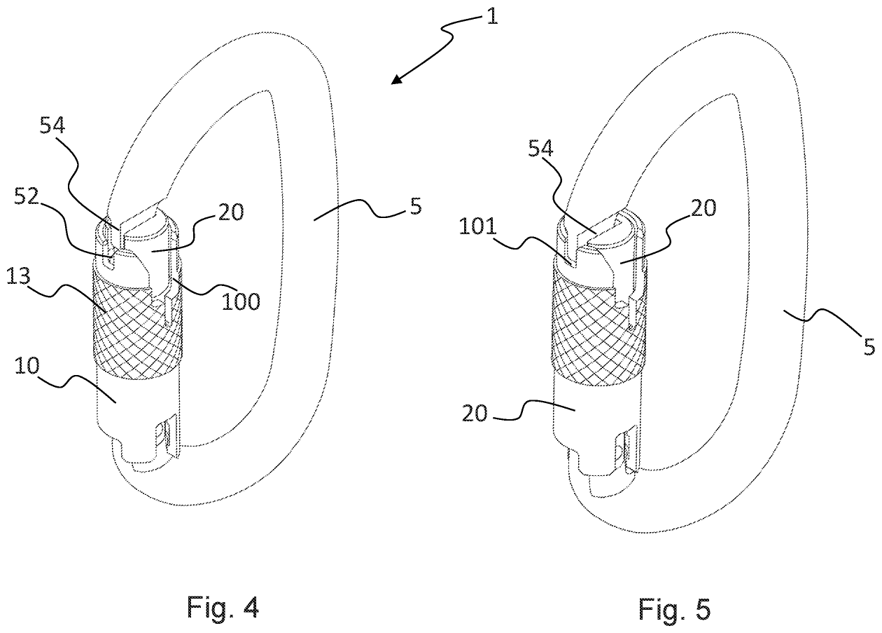

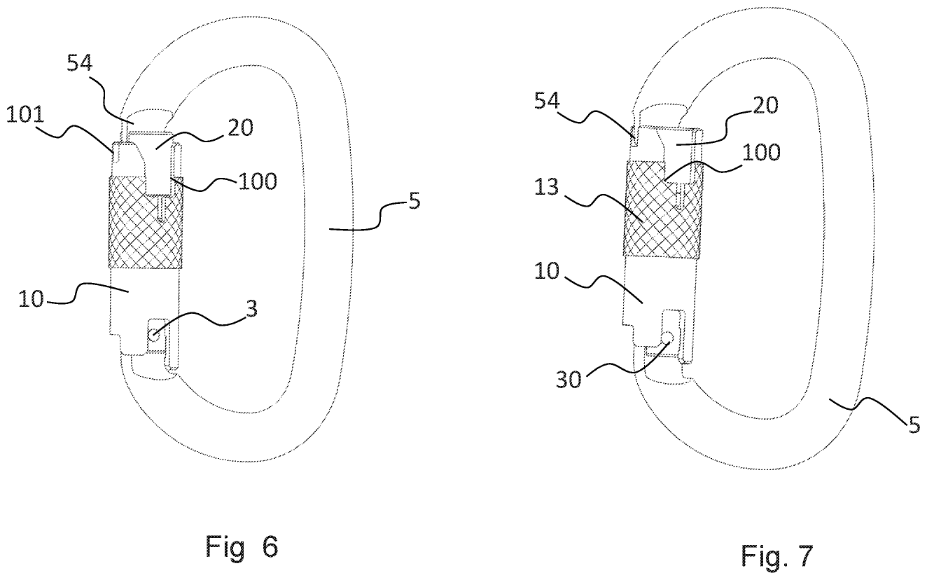

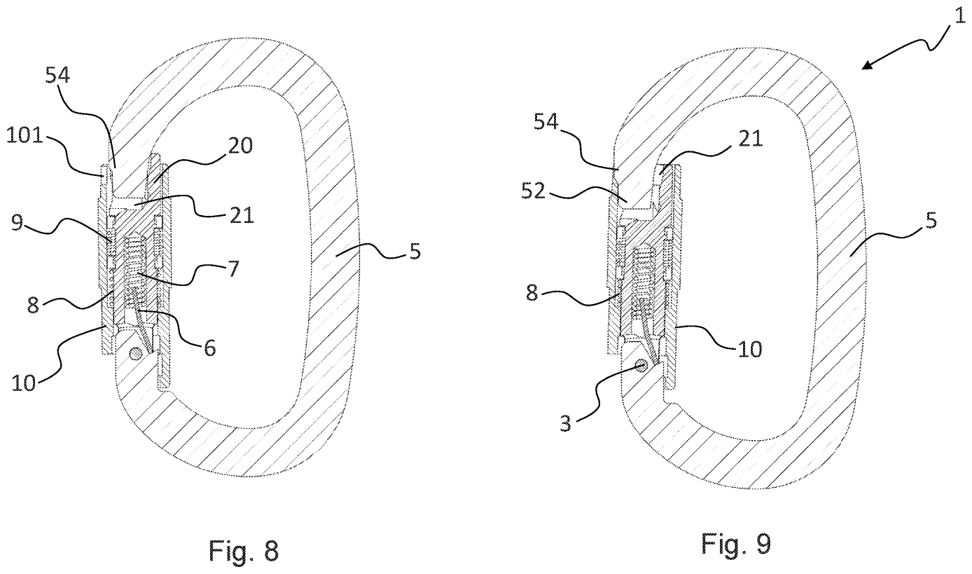

This situation is illustrated in several views of the pairs of FIGS. 4-5, 6-7 and 8-9, wherein it can be seen that, starting from a condition in which the gate 10 is slightly turned from the idle condition (FIGS. 4, 6, 8), if an external force tends to move the finger 2 inwards (clockwise in FIGS. 5, 7 and 9) towards the inside of the body 5, the septum 54 of the nose 52 will engage the seat 101 of the gate 10, thereby preventing the latter from turning any further.

This condition represents, therefore, a safety lock of the connector, adding to the succession of the phases i)→ii)→iii) described above.

In light of this explanation, it can be understood how the present invention can solve the technical problem at the basis thereof.

In fact, the solution described herein allows the mechanism to discern between intentional and accidental opening, so that the connector will open only when the correct sequence of movements i)→ii)→iii) is executed.

On the contrary, whenever a single unintentional external force triggers a movement before the previous movement has begun, that is, when the correct sequence is not observed, the safety system will enter a safety locking mode wherein the previous movement will be prevented until such force stops being applied and the systems returns, in the absence of any external stimuli, into the initial condition.

This result is attained in a simple and effective manner due to the presence of the second notch 101 on the gate 10, the configuration and position of which are such as to facilitate its engagement with the septum 54 of the body 5.

However, this solution is not bound to the shape of the engagement notch, which in the example shown herein runs through the entire thickness of the gate 10, since it may alternatively be machined just partially without running through the entire thickness of the gate, but remaining inside of it, or, as a further alternative, it may not reach the top end of the gate, being machined as a slot or a hole.

Furthermore, the solution disclosed herein can be adapted to carabiners provided with other types of opening mechanisms, since it is based on the concept of movement sequentiality and on the activation of a safety locking mode when an incorrect sequence is executed.

More specifically, let us consider carabiners equipped with a screw gate, wherein the engagement will retain the locked position and will prevent accidental unscrewing, or automatic carabiners equipped with a gate that translates along its axis (by means of a spring-type system that moves the gate upwards to close the hook), wherein the retaining cavity may be a hole or a slot contained within the dimension of the gate, which engages with a hook of the carabiner suitably shaped with an engagement tooth.

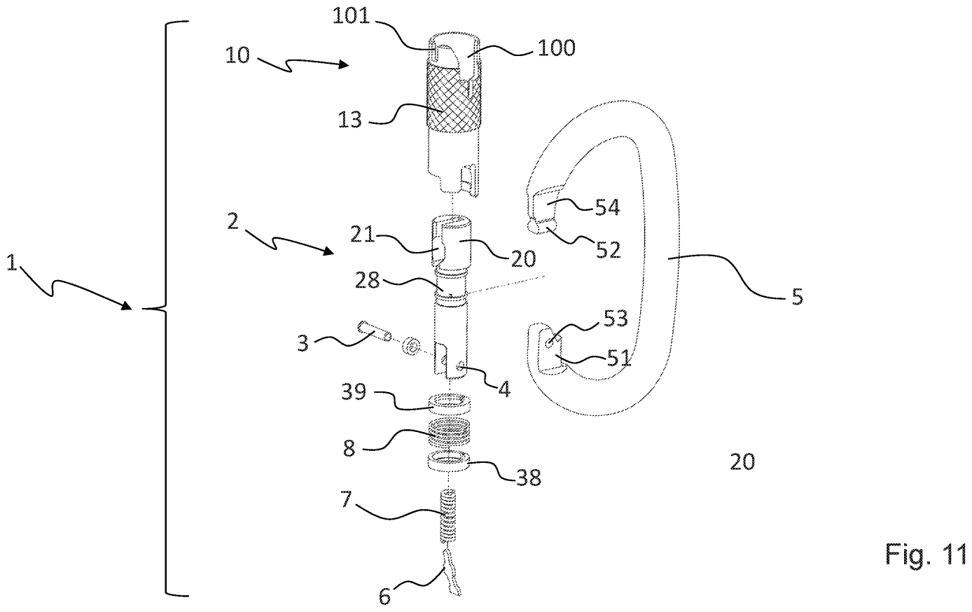

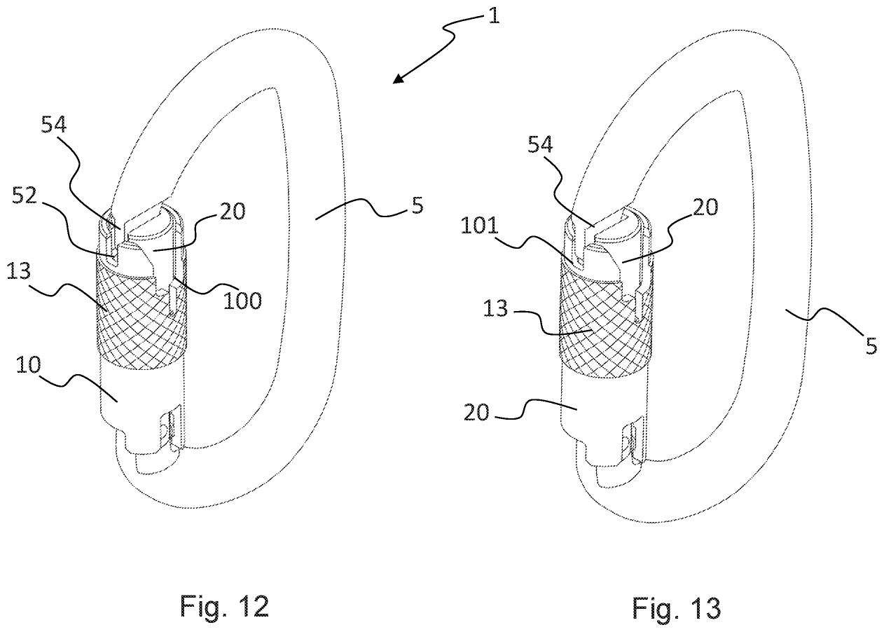

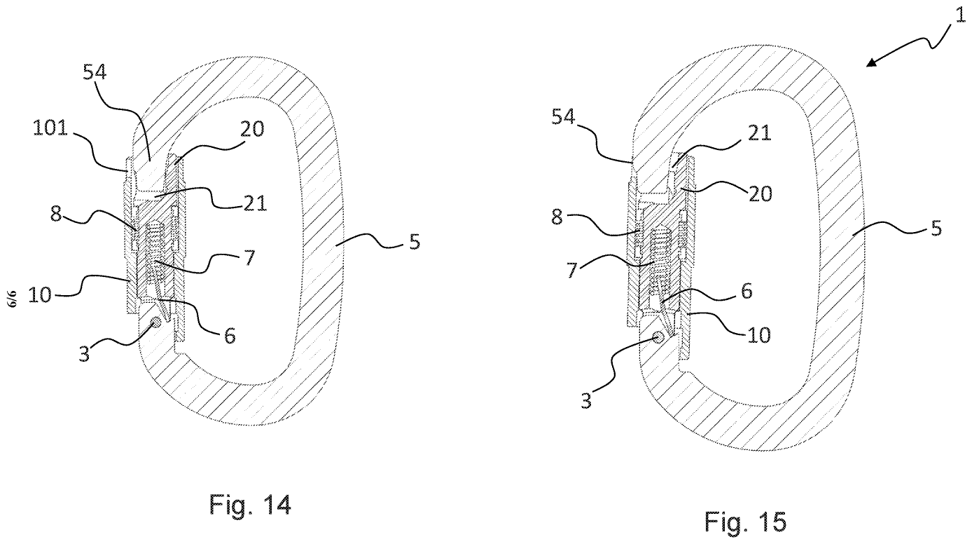

Another possible variant is illustrated in FIGS. 11-15, which show, through views that are similar to those of the first example, a twist-type connector 1, i.e. a connector requiring two movements; for simplicity and ease of understanding, in FIGS. 11-15 the same reference numerals already employed in the preceding drawings have been used to designate identical or equivalent elements.

For brevity's sake, the latter will not be described any further, and reference should be made to the above description.

Essentially, the variant shown in FIGS. 11-15 differs from the previous one in that the finger 20 of the connector can be opened by executing a sequence of just two movements:
ii) a clockwise rotational movement;
iii) an inward movement of the finger 2.

For this reason, the mechanism of the gate 10 comprises just a single spring 8 outside the finger 2, instead of the two springs employed in the previous example.

At any rate, the same safety considerations already made above also apply to the closing of the finger 2, which is ensured by the second notch 101, into which the septum 54 of the connector nose 52 is engaged.

To understand this, reference can be made to the explanations provided for the previous example, which also apply mutatis mutandis to this variant.

In this case, in fact, the gate 10 can only make a rotational movement (twist) about its own axis, with no axial translation; this simplifies the procedure for opening the connector 1, but reduces the degree of safety, which is dependent on the sequence of movements required to open the connector.

For this reason, the invention appears to be particularly advantageous for such an application, since the engagement of the nose 54 of the body 5 of the connector into the safety notch or cavity 101 makes it possible to prevent the arm 2 from opening under forces tending to execute the reverse sequence of movements iii)→ii).

All such features shall nevertheless fall within the scope of the following claims.

1. Connector (1) comprising a hook-shaped body (5), a finger (2) connected to the hook-shaped body (5) and oscillating between a closed condition, in which it is engaged with one end (52) of the body (5), and an open condition in which it is separated from the same, in contrast to the elastic action of at least one spring (7), a gate (10) coupled with the oscillating finger (2) for locking the latter in its closed condition, wherein the gate (10) is movable along its longitudinal axis and rotatable about it for opening and closing the finger (2), characterized in that the gate comprises at least one safety notch (101) adapted to engage with a septum (54) of the nose (52) of the body (5) when the finger (2) makes an opening movement from a closed condition.

2. Connector according to claim 1, comprising at least one spring (8, 9) of elastic contrast to the translational and rotational movements of the gate (10).

3. Connector according to claims 1 or 2, wherein the notch (101) is disposed on the gate (10) with an offset of approx. 90° relative to a main notch (100) allowing the nose (52) of the body (5) to pass when the gate is turned for opening the finger (2).

4. Connector according to any one of the preceding claims, wherein the opening of the finger (2) occurs after a succession of the following movements:
i) an axial translational movement of the gate (19);
ii) a rotational movement of the gate (10) to align the main notch (100) with the nose (52) of the body (5);
iii) a movement of the finger (2) towards the inside of the connector for opening it.

5. Connector according to claim 4, further comprising:
iv) a condition in which a rotation of the gate (10) is prevented, wherein the safety notch (101) is engaged with a septum (54) of the nose (52) of the body (5), in the event that the sequence of movements i)→ii)→iii) is not executed.

6. Connector according to any one of claims 1 to 3, wherein the opening of the finger (2) occurs after a succession of the following movements:
ii) a rotational movement of the gate (10) to align the main notch (100) with the nose (52) of the body (5);
iii) a movement of the finger (2) towards the inside of the connector for opening it.
